(19) United States
(12) Patent Application Publication
(10) Pub. No.: US 2022/0154320 A1
(43) Pub. Date: May 19, 2022

(54) MOLTEN Zn-Al-Mg-PLATED STEEL SHEET AND METHOD FOR PRODUCING SAME

(71) Applicant: NIPPON STEEL CORPORATION, Tokyo (JP)

(72) Inventors: Shinya UESUGI, Tokyo (JP); Kentaro HIRATA, Tokyo (JP)

(21) Appl. No.: 17/438,440

(22) PCT Filed: Mar. 18, 2020
(86) PCT No.: PCT/JP2020/011959

§ 371 Date: Sep. 12, 2021

(30) Foreign Application Priority Data
Mar. 22, 2019 (JP) 2019-055044

(51) Int. Cl. C23C 2/06; C21D 8/02; C23C 2/40; C22C 38/26; C22C 38/24; C22C 38/22; C22C 38/28; C22C 38/32; C22C 38/38; C22C 38/02; C22C 38/06; C22C 38/00

(52) U.S. Cl. CPC C23C 2/06; C21D 2211/003; C21D 8/0226; C23C 2/40; C22C 38/26; C22C 38/24; C22C 38/22; C22C 38/28; C22C 38/32; C22C 38/38; C22C 38/02; C22C 38/06; C22C 38/002; C21D 2211/005; C21D 2211/008; C21D 8/0205

(57) ABSTRACT

Provided is a plated steel sheet having both strength and workability. In a hot-dip Zn—Al—Mg-based plated steel sheet, the steel substrate contains C in an amount of 0.050 to 0.180% by mass, Si in an amount of 0.001 to 0.50% by mass, Mn in an amount of 1.00 to 2.80% by mass, Ti in an amount of 0.01 to 0.10% by mass, and B in an amount of 0.0005 to 0.0100% by mass, an average grain size of cementite after winding in a hot rolling step is not greater than 2 μm, a metal structure after a continuous hot-dip galvanizing step includes a ferrite phase and not less than 15 and less than 45% by area of a second phase, and the second phase is composed of martensite or composed of martensite and bainite and has an average crystal grain size of not greater than 8 μm.

### TECHNICAL FIELD

The present invention relates to a hot-dip Zn—Al—Mg-based plated steel sheet and a method of producing the hot-dip Zn—Al—Mg-based plated steel sheet.

### BACKGROUND ART

In recent years, there are increasing needs for high-strength, highly rust resistant steel sheets aiming at weight reduction and resource savings in the fields of automobiles and construction materials. Such a high-strength, highly rust resistant steel sheet is subjected to various types of processing such as pressing and bending, and therefore it is important that the high-strength, highly rust resistant steel sheet not only have high strength and high corrosion resistance but also have excellent workability. However, the workability of materials deteriorates as the strength increases; therefore, there is a demand for establishment of a technique that can achieve both high strength, such as, for example, a maximum tensile strength of not less than 780 MPa required for automotive structural components and reinforcing components, and workability.

For example, Patent Literature 1 discloses a technique that achieves both a high tensile strength of not less than 780 MPa and workability, by adding Si, Nb, and Ti to a steel sheet and thereby reducing the difference in hardness between a hard phase, such as martensite and a bainitic structure, and a ferrite phase.

Furthermore, in terms of corrosion resistance, a hot-dip Zn—Al—Mg-based plated steel sheet is known as a surface-treated steel sheet which has a high anti-rust effect. In recent years, there are increasing needs for steel sheets having black appearance in terms of design etc.; therefore, there is an increasing demand for a hot-dip Zn—Al—Mg-based plated steel sheet having a plating which itself is blackened. Patent Literature 2 discloses a hot-dip Zn—Al—Mg-based plated steel sheet which has high strength, which is a tensile strength of not less than 780 MPa, and is excellent in bending workability.

### CITATION LIST

### Patent Literature

[Patent Literature 1]

Japanese Patent Application Publication, Tokukai, No. 2006-283156

[Patent Literature 2]

Japanese Patent Application Publication, Tokukai, No. 2014-189812

### SUMMARY OF INVENTION

### Technical Problem

However, the addition of a large amount of Ti to a steel sheet would lead to an increase in recrystallization temperature, and therefore high reduction/heating temperature would be necessary during a plating step. An increase in reduction/heating temperature may cause plating defects, and therefore the technique disclosed in Patent Literature 1 is not suitable for plated steel sheets. Furthermore, with the production method disclosed in Patent Literature 2, the amount of martensite after plating may decrease depending on the conditions under which hot rolling is carried out, and therefore there are cases in which a strength not less than 780 MPa is not obtained stably.

An object of an aspect of the present invention is to provide a hot-dip Zn—Al—Mg-based plated steel sheet that stably achieves both a tensile strength of not less than 780 MPa and high workability.

### Solution to Problem

In order to attain the above object, a hot-dip Zn—Al—Mg-based plated steel sheet in accordance with an aspect of the present invention is a hot-dip Zn—Al—Mg-based plated steel sheet having a hot-dip Zn—Al—Mg-based plating on a surface of a steel substrate, in which: the steel substrate contains C in an amount of 0.050% by mass to 0.180% by mass, Si in an amount of 0.001% by mass to 0.50% by mass, Mn in an amount of 1.00% by mass to 2.80% by mass, Ti in an amount of 0.01% by mass to 0.10% by mass, and B in an amount of 0.0005% by mass to 0.0100% by mass, with the balance including Fe and unavoidable impurities; an average grain size of cementite after winding in a hot rolling step is not greater than 2 μm; a metal structure after a continuous hot-dip galvanizing step includes a ferrite phase and not less than 15% by area and less than 45% by area of a second phase; and the second phase is composed of martensite or composed of martensite and bainite, and has an average crystal grain size of not greater than 8 μm.

In order to attain the above object, a method of producing a hot-dip Zn—Al—Mg-based plated steel sheet in accordance with an aspect of the present invention is a method of producing a hot-dip Zn—Al—Mg-based plated steel sheet having a hot-dip Zn—Al—Mg-based plating on a surface of a steel substrate, including: a hot rolling step; a cold rolling step; and a continuous hot-dip galvanizing step in the order stated, the continuous hot-dip galvanizing step including sequentially carrying out annealing and hot-dip Zn—Al—Mg-based plating, in which, in the hot rolling step, an average cooling rate after hot rolling is not less than 20° C./second and less than 80° C./second, and a winding temperature is not lower than 400° C. and lower than 600° C.

### Advantageous Effects of Invention

An aspect of the present invention makes it possible to provide a hot-dip Zn—Al—Mg-based plated steel sheet that stably achieves both a tensile strength of not less than 780 MPa and high workability.

### BRIEF DESCRIPTION OF DRAWINGS

FIG. 1 is a table showing components of each type of steel in Examples of the present invention.

FIG. 2 is a table showing production conditions and characteristics of each type of steel in Examples of the present invention.

### DESCRIPTION OF EMBODIMENTS

The following description will discuss an embodiment of the present invention in detail. Note that the following description is to help better understand the gist of the invention, and is not intended to limit the present invention unless otherwise noted. Furthermore, numerical ranges expressed in the form of “A to B” mean “not less than A and not more than B”, unless otherwise specifically noted herein.

[Chemical Composition of Substrate Steel Sheet]

The following description discusses constituent elements of a substrate steel sheet, which corresponds to a substrate to be plated. In the present specification, “%” concerning the chemical composition of a substrate steel sheet means “% by mass”, unless otherwise specifically noted.

(C)

Carbon (C) is an element necessary to increase the strength of steel. In order to obtain a strength level of “tensile strength of not less than 780 MPa”, a C content of not less than 0.050% is necessary. Note, however, that, if the C content is too much, non-uniformity of the structure becomes apparent, resulting in a reduction in workability. Therefore, the C content may be limited to 0.180% or less and may be controlled to be 0.160% or less.

(Si)

Silicon (Si) is effective in increasing strength, and also has the function of inhibiting the precipitation of cementite and is effective in inhibiting the generation of pearlite and the like. In order to allow Si to exert such effects sufficiently, a Si content of not less than 0.001% is ensured. Note, however, that a large amount of Si contained may cause generation of a Si concentrated layer on the surface of a steel sheet, and may cause a reduction in platability. Therefore, the Si content is preferably limited to 0.50% or less, and is more preferably 0.25% or less.

(Mn)

Manganese (Mn) is effective in increasing strength. For the purpose of stably obtaining a strength level of “tensile strength of not less than 780 MPa”, a Mn content of not less than 1.00% is ensured. Note, however, that if the Mn content is too much, segregation is likely to occur, resulting in a reduction in workability. Therefore, the Mn content is not more than 2.80%.

(Ti)

The steel sheet contains Ti (titanium) in an amount of not less than 0.01% by mass and not more than 0.1% by mass. Ti is an element which, when reacts with C, causes precipitation of a Ti-containing carbide in the form of fine particles and is effective in increasing the strength of the steel sheet. Furthermore, Ti has high affinity with sulfur (S) and nitrogen (N) in the steel, and therefore not only reacts with C to produce precipitates but also reacts with S and N to produce precipitates. B, which is required to inhibit austenite-ferrite transformation, easily binds to N; therefore, the addition of Ti is effective in achieving the amount of B in the form of a solute in a solid solution. When the Ti content is not less than 0.01% by mass, the amount of B in the form of a solute in a solid solution, required to inhibit austenite-ferrite transformation, is achieved, and the effect of producing fine precipitates becomes apparent. Furthermore, when the Ti content is not more than 0.1% by mass, the Ti content in the substrate steel sheet is not excessive, making it possible to reduce the production cost for the substrate steel sheet.

(B)

Boron (B) inhibits austenite-ferrite transformation of steel and contributes to increasing the strength of a transformation structure. B has the effect of inhibiting austenite-ferrite transformation, thereby lowering the temperature at which a Ti-based carbide and the like start precipitating and making such carbides fine-grained. For the purpose of obtaining such an effect sufficiently, a B content of not less than 0.0005% is ensured. A B content of not less than 0.0010% is more effective. Note, however, that a large amount of B contained may cause a reduction in workability that would result from generation of a boride. In a case where B is added, the amount of B needs to be 0.0100% or less, and may be controlled to be 0.0050% or less.

(P)

Phosphorus (P) is effective for solid solution strengthening, and therefore it is preferable that a P content of not less than 0.005% be ensured. The P content may be controlled to be 0.010% or more. Note, however, that if the P content is too much, segregation is likely to occur, resulting in a reduction in workability. The P content is limited to 0.050% or less.

(S)

Sulfur (S) may cause a reduction in workability. An S content of up to 0.020% is tolerable. Note, however, that too low an S content may result in an increased load in steelmaking, and therefore the S content may usually be 0.001% or more.

(Al)

Aluminum (Al) has a deoxidation effect. For the purpose of allowing Al to sufficiently exert the effect, it is preferable that Al be added such that the Al content of steel is not less than 0.005%. Note, however, that too much Al content may result in a reduction in workability. Therefore, the Al content is limited to 0.100% or less, and may be controlled to be 0.050% or less.

(Nb, V)

Similar to Ti, niobium (Nb) and vanadium (V) improve the uniformity of the structure by making the structure fine-grained and dispersing carbide particles to a greater extent, and contribute to increasing strength without causing a deterioration of workability such as bendability. Therefore, one of or both of Nb and V may be contained as necessary. For the purpose of sufficiently obtaining the above effects, it would be more effective if a Nb content of not less than 0.01% is ensured and a V content of not less than 0.03% is ensured. Note, however, that too large amounts of such elements contained may result in a reduction in workability. Therefore, in a case where one of or both of such elements is/are added, the Nb content is 0.10% or less and the V content is also 0.10% or less.

(Mo, Cr)

Molybdenum (Mo) and chromium (Cr) both have the effect of increasing strength via solid solution strengthening, and therefore one of or both of Mo and Cr may be contained as necessary. In order to allow Mo and Cr to sufficiently exert the above effect, it is more effective if an Mo content of not less than 0.01% is ensured and a Cr content of not less than 0.01% is also ensured. Note, however, that too much of such elements contained may result in a reduction in ductility. Therefore, in a case where one of or both of such elements is/are added, the Mo content is 1.00% or less and the Cr content is also 1.00% or less.

A steel sheet in accordance with the present embodiment contains C, Si, Mn, Ti, and B, and may further contain any of the foregoing elements as other element(s). In a preferred embodiment, the steel sheet further contains at least one of the following: P, S, and Al. In a more preferred embodiment, the steel sheet further contains all of the following: P, S, and Al. In another embodiment, a steel sheet contains C, Si, Mn, Ti, and B, and further contains at least one, preferably all, of the following: P, S, and Al, in which the steel sheet further contains at least one of the following: Nb, V, Cr, and Mo. Note that the balance includes Fe and unavoidable impurities.

[Metal Structure of Steel Substrate]

In the present invention, a steel substrate employed is a dual-phase (DP) steel sheet having a composite structure in which martensite as a second phase or martensite and bainite as a second phase is/are dispersed in ferrite as a main phase. In a metal structure after hot-dip galvanization, the second phase composed of martensite or composed of martensite and bainite, dispersed in ferrite as the main phase, is not less than 15% by area and less than 45% by area. If the second phase is less than 15% by area, it would be difficult to stably obtain a tensile strength of not less than 780 MPa. On the contrary, if the second phase is equal to or more than 45% by area, the steel sheet is too hard and workability decreases.

The second phase is most preferably martensite alone, but may have bainite partially dispersed therein. For example, it is more preferable that the percentage by volume of bainite relative to the total volume of martensite and bainite be within the range of 0% to 5%. Examples of the present invention in Examples described later each satisfy this condition.

In the present invention, workability is improved by making the structure fine-grained. In consideration of the cases where a plated steel sheet having a thickness of about 0.8 mm to 2.0 mm is used to produce an automotive structural component and reinforcing component, it was found that, fine-graining the average crystal grain size of the second phase to be 8 pm or less ensures sufficient workability and is effective for expanding design freedom. It is preferable that ferrite as the main phase be also made fine-grained; however, with regard to workability, the average crystal grain size of the second phase is particularly important.

When the production conditions (described later) under which the second phase will have an average crystal grain size of not greater than 8 μm are employed, the ferrite phase will also be made fine-grained enough. For example, the average crystal grain size of the ferrite phase becomes 10 μm or less. In Examples described later, in each of steel sheets in which the second phase has an average crystal grain size of not greater than 8 μm, the average crystal grain size of the ferrite phase is not greater than 10 μm.

[Production Method]

The foregoing hot-dip Zn—Al—Mg-based plated steel sheet can be produced using a production line for typical hot-dip zinc-based plated steel sheets, in which a steel slab is subjected to the steps of hot rolling, pickling, cold rolling, annealing, and hot-dip galvanizing in the order stated. In order to achieve both the strength and workability of steel, it is necessary to control the chemical composition of the steel substrate and also specially design the production conditions so that the crystal grain size will be made fine enough. Specifically, the hot rolling step is configured such that average cooling rate is not less than 20° C./second and less than 80° C./second and that winding temperature is not lower than 400° C. and lower than 600° C.

Note that it is more preferable that hot rolling be carried out with a finish rolling temperature of 830° C. to 940° C. in the hot rolling step, cold rolling reduction ratio be 40% to 70% in the cold rolling step, annealing be carried out at 740° C. to 880° C. in the annealing step, and then the average cooling rate at which the temperature is lowered to at least 450° C. during the cooling process before dipping in a plating bath be not less than 5° C./second.

(Hot Rolling Step)

In the hot rolling step, the finish rolling temperature in hot rolling is preferably 830° C. to 940° C.

Since the finish rolling temperature is not lower than 830° C., the deformation resistance of the steel sheet does not become high and it is possible to prevent a reduction in produceability of the steel sheet via hot rolling. Furthermore, since the finish rolling temperature is not higher than 940° C., it is possible to prevent the occurrence of scale marks in the coil surface and prevent or reduce a deterioration of surface quality.

The steel sheet after finish rolling (hot-rolled steel sheet) is cooled to a winding temperature of not lower than 400° C. and lower than 600° C. at an average cooling rate of not less than 20° C./second and less than 80° C./second. In a case where the average cooling rate is not more than 20° C./second or in a case where the winding temperature is not lower than 600° C., cementite in the hot-rolled steel sheet structure becomes coarse, and the coarse cementite will partially remain as undissolved carbide during reduction/heating in the hot-dip galvanizing step. As a result, the amount of martensite after hot-dip galvanizing decreases, and a tensile strength of not less than 780 MPa cannot be obtained. Furthermore, in a case where the average cooling rate is not less than 80° C./second or in a case where the winding temperature is lower than 400° C., the dislocation density increases and therefore the hardness of the hot-rolled steel sheet increases. This not only results in an increase in load during the cold rolling step but also results in a reduction in workability after the hot-dip galvanizing step.

When the average cooling rate is not less than 20° C./second and less than 80° C./second and the winding temperature is not lower than 400° C. and lower than 600° C., the grain size of cementite after winding in hot rolling will be not more than 2 μm. This makes it possible to reduce the remaining undissolved carbide during reduction/heating in the hot-dip galvanizing step, and therefore the amount of martensite after hot-dip galvanizing increases. This makes it possible to stably produce a plated steel sheet that achieves both a high strength of not less than 780 MPa and a high level of workability.

(Cold Rolling Step)

In the cold rolling step, the cold rolling reduction ratio is preferably 40% to 70%. When the cold rolling reduction ratio is less than 40%, the structure after annealing becomes coarse, and bendability decreases. On the other hand, when the cold rolling reduction ratio is more than 70%, the effect of making the structure fine-grained by cold rolling is saturated. Furthermore, imparting too high a cold rolling reduction ratio is not preferable because this causes an increase in load in the cold rolling step. The thickness of the sheet after the hot rolling is adjusted according to the final target thickness of the sheet so that the cold rolling reduction ratio in the cold rolling step will be within the above range. Under certain circumstances, the step of “intermediate cold rolling+intermediate annealing” may be inserted between the hot rolling and the cold rolling step.

(Continuous Hot-Dip Galvanizing Step)

In a continuous hot-dip galvanizing step, annealing and hot-dip Zn—Al—Mg-based plating are carried out sequentially.

In annealing that is carried out immediately before dipping in a hot-dip galvanizing bath, heating may be carried out in a reducing atmosphere so that the material temperature (maximum reachable temperature) reaches 740° C. to 880° C. If the material temperature does not reach 740° C., recrystallization does not occur sufficiently and unrecrystallized structures are likely to remain, and therefore it is difficult to stably obtain good workability. If the material temperature exceeds 880° C., crystal grains of the austenite parent phase become coarse, and the second phase is not made fine-grained enough to impart good workability. The time for which the material temperature is maintained within the range of 740° C. to 880° C. may be set to be, for example, 60 seconds or shorter.

In the cooling process after the annealing, the average cooling rate before at least 450° C. is reached is preferably not less than 5° C./second. If the cooling rate in this temperature range is less than 5° C./second, pearlite is likely to be produced locally, and it becomes difficult to stably obtain a high strength of not less than 780 MPa. Also in terms of making the grain size of ferrite and grain size of the second phase, a cooling rate of not less than 5° C./second is effective. As described earlier, steel to which the present invention is applied contains a certain amount of Ti and, as necessary, Nb; therefore, by selecting the cooling rate after heating in such a manner, it is possible to obtain a fine structure in which the average crystal grain size of ferrite is not greater than 10 μm and in which the average crystal grain size of the second phase is not greater than 8 μm.

Such annealing is carried out preferably using a continuous plating line in which annealing and hot-dip Zn—Al—Mg-based plating can be carried out by passing a sheet through the line once. In the cooling after annealing, cooling is carried out until an appropriate material temperature for dipping in a hot-dip galvanizing bath is reached, and the steel sheet is dipped directly in the hot-dip galvanizing bath. The annealing atmosphere is a reducing atmosphere, and is controlled so that the steel sheet does not come into contact with the air until the steel sheet is dipped in the hot-dip galvanizing bath.

Hot-dip Zn—Al—Mg-based plating can be carried out by a conventionally used method. The composition of the plating bath is, for example, preferably as follows: Al in an amount of 3.0% by mass to 22.0% by mass; Mg in an amount of 0.05% by mass to 10.0% by mass; Ti in an amount of 0% by mass to 0.10% by mass; B in an amount of 0% by mass to 0.05% by mass; Si in an amount of 0% by mass to 2.0% by mass; and Fe in an amount of 0% by mass to 2.0% by mass, with the balance being Zn and unavoidable impurities. The composition of the plating layer of the obtained plated steel sheet would be substantially the same as the composition of the plating bath.

The obtained plated steel sheet is brought into contact with steam in a well-closed container, and the plating is blackened. This step makes it possible to reduce the lightness (L* value) of the surface of the plating to 60 or less (preferably 40 or less, more preferably 35 or less). With this, the following steel sheet is obtained: a black oxide of Zn is present in a surface layer of the hot-dip Zn—Al—Mg-based plating, and the lightness L* of the surface is 60 or less. When the surface layer of the plated steel sheet has such lightness, a black-color plated steel sheet excellent in design is obtained. Note that the time or which the plated steel sheet is subjected to stem, and the like, are selected as appropriate according to the desired lightness L*. The lightness (L* value) of the surface of the plating is measured using a spectrophotometric colorimeter.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

Examples of the present invention are described below.

[Test Method]

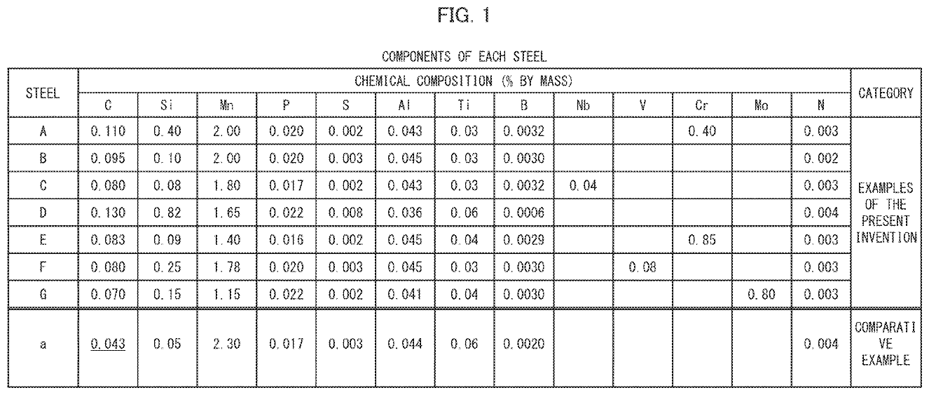

A slab having the chemical composition shown in FIG. 1 was subjected to hot rolling under the conditions in which the heating temperature was 1250° C., finish rolling temperature was 880° C., the average cooling rate from the finish rolling to winding was 15° C./second to 70° C./second, and the winding temperature was 420° C. to 630° C. In this way, a hot-rolled steel sheet having a thickness of 1.8 mm to 2.8 mm was obtained. The hot-rolled steel sheet was subjected to pickling, and then subjected to cold rolling at a reduction ratio of 45% to 65% to obtain a substrate to be plated (steel substrate) having a thickness of 1.0 mm. This substrate was passed through a continuous hot-dip plating line, subjected to annealing at varying temperatures between 750° C. and 850° C. in a hydrogen-nitrogen mixed gas atmosphere, and cooled to about 420° C. at a cooling rate of 8° C./second to 12° C./second.

After that, the steel sheet was dipped in the hot-dip Zn—Al—Mg-based plating bath having the following bath composition while ensuring that the surface of the steel sheet was not in contact with the air and then pulled up, and the amount of adhering plating was adjusted by a gas wiping process to about 90 g/m² per side. In this way, a hot-dip Zn—Al—Mg-based plated steel sheet was produced, and was used as a sample material. The temperature of the plating bath was about 410° C.

The composition of the plating bath is as follows. Al: 6% by mass, Mg: 3% by mass, Ti: 0.002% by mass, B: 0.0005% by mass, Si: 0.01% by mass, Fe: 0.1% by mass, Balance: Zn.

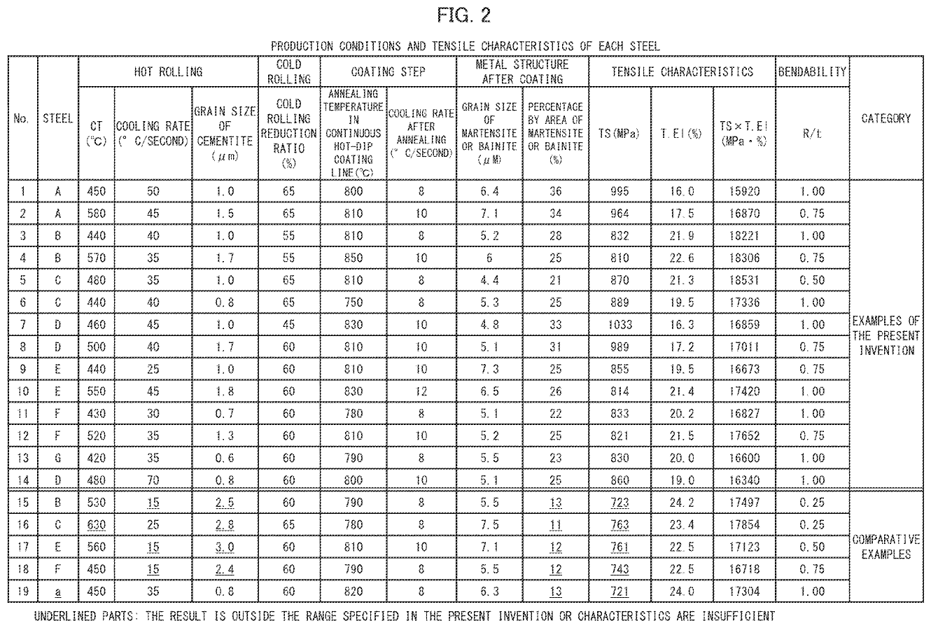

FIG. 2 shows conditions under which each steel sheet (steel A to steel G of Examples of the present invention, and steel a of Comparative Example) was produced. In FIG. 2, “CT” represents winding temperature, “cooling rate” represents average cooling rate from finish rolling to winding in hot rolling, and “annealing temperature” represents reduction/heating temperature in a continuous hot-dip galvanizing line.

[Test Items]

The following tests were conducted on plated steel sheets which are the obtained sample materials.

(Tensile Characteristics)

With use of a JIS5 test piece taken such that the longitudinal direction of the test piece would be orthogonal to the direction of rolling of the substrate to be plated (steel substrate), tensile strength TS and total elongation T.E1 were determined in accordance with JIS Z2241.

(Bending Test)

With use of a bending test piece taken such that the longitudinal direction of the test piece would be orthogonal to the direction of rolling of the substrate to be plated (steel substrate), a V-block bend test at a bending angle of 45 degrees was carried out in accordance with JIS Z2248. After the test, the bent portion was visually checked from outside the bent portion, and the minimum inside radius of the bent portion at which cracks did not appear was calculated as the minimum bend radius R. The value obtained by dividing the minimum bend radius R by the thickness t of the sheet was determined as an indicator of bendability R/t.

(Metal Structure)

With regard to the metal structures of a hot-rolled material and a plated material, a cur surface parallel to the direction of rolling (L cross section) was observed under a scanning electron microscope. With regard to the hot-rolled material, the hot-rolled material was etched using a picral reagent and then ten fields of view were subjected to image analysis, and the average grain size of cementite was determined.

Each of the plated materials showed a metal structure in which the main phase is ferrite and martensite is present as a second phase or martensite and bainite are present as a second phase. Ten fields of view were subjected to image analysis, and the percentage by area of the second phase and the average crystal grain size (equivalent circle diameter) were determined.

[Test Results]

The results of tests on the foregoing test items are collectively shown in FIG. 2. Note that the underlined items in FIG. 2 show that the result is outside the range specified in the present invention or characteristics are insufficient.

The steel sheets of Examples of the present invention each showed the following: the grain size of cementite of the hot-rolled material is not greater than 2 μm, the percentage by area of the second phase composed of martensite or composed of martensite and bainite in the plated material is not less than 15% and less than 45%, the average crystal grain size of the second phase is not greater than 8 μm, the tensile strength TS is not less than 780 MPa, the tensile strength TS×total elongation T.E1 is not less than 14000 MPa %, and the indicator of bendability R/t is not more than 1.5. That is, in Examples of the present invention, a plated steel sheet having both a high level of strength and a high level of workability was obtained stably.

On the contrary, with regard to each of the sample materials (Comparative Examples) which was produced under the conditions in which one or more of the following was outside the range specified in the present invention: chemical composition of the steel sheet; winding temperature (CT); and the average cooling rate from finish rolling to winding, the percentage by area of the second phase was less than 15% and the tensile strength TS was not more than 780 MPa. That is, it was not possible to obtain a plated steel sheet satisfying the strength required in the present invention.

Aspects of the present invention can also be expressed as follows:

A hot-dip Zn—Al—Mg-based plated steel sheet in accordance with an aspect of the present invention is a hot-dip Zn—Al—Mg-based plated steel sheet having a hot-dip Zn—Al—Mg-based plating on a surface of a steel substrate, in which: the steel substrate contains C in an amount of 0.050% by mass to 0.180% by mass, Si in an amount of 0.001% by mass to 0.50% by mass, Mn in an amount of 1.00% by mass to 2.80% by mass, Ti in an amount of 0.01% by mass to 0.10% by mass, and B in an amount of 0.0005% by mass to 0.0100% by mass, with the balance including Fe and unavoidable impurities; an average grain size of cementite after winding in a hot rolling step is not greater than 2 μm; a metal structure after a continuous hot-dip galvanizing step includes a ferrite phase and not less than 15% by area and less than 45% by area of a second phase; and the second phase is composed of martensite or composed of martensite and bainite, and has an average crystal grain size of not greater than 8 μm.

The hot-dip Zn—Al—Mg-based plated steel sheet in accordance with an aspect of the present invention may further contain at least one of the following: P in an amount of 0.005% by mass to 0.050% by mass; S in an amount of 0.001% by mass to 0.020% by mass; and Al in an amount of 0.005% by mass to 0.100% by mass.

The hot-dip Zn—Al—Mg-based plated steel sheet in accordance with an aspect of the present invention may further contain at least one of the following: Nb in an amount of 0% by mass to 0.10% by mass; V in an amount of 0% by mass to 0.10% by mass; Cr in an amount of 0% by mass to 1.00% by mass; and Mo in an amount of 0% by mass to 1.00% by mass.

The hot-dip Zn—Al—Mg-based plated steel sheet in accordance with an aspect of the present invention may be configured such that: in a surface layer of the hot-dip Zn—Al—Mg-based plating, a black oxide of Zn is present; and a lightness L* of a surface of the surface layer of the hot-dip Zn—Al—Mg-based plating is not more than 60.

A method of producing a hot-dip Zn—Al—Mg-based plated steel sheet in accordance with an aspect of the present invention is a method of producing a hot-dip Zn—Al—Mg-based plated steel sheet having a hot-dip Zn—Al—Mg-based plating on a surface of a steel substrate, including: a hot rolling step; a cold rolling step; and a continuous hot-dip galvanizing step in the order stated, the continuous hot-dip galvanizing step including sequentially carrying out annealing and hot-dip Zn—Al—Mg-based plating, in which, in the hot rolling step, an average cooling rate after hot rolling is not less than 20° C./second and less than 80° C./second, and a winding temperature is not lower than 400° C. and lower than 600° C.

The method of producing a hot-dip Zn—Al—Mg-based plated steel sheet in accordance with an aspect of the present invention may be arranged such that: the steel substrate contains C in an amount of 0.050% by mass to 0.180% by mass, Si in an amount of 0.001% by mass to 0.50% by mass, Mn in an amount of 1.00% by mass to 2.80% by mass, Ti in an amount of 0.01% by mass to 0.10% by mass, and B in an amount of 0.0005% by mass to 0.0100% by mass, with the balance including Fe and unavoidable impurities; an average grain size of cementite after winding in the hot rolling step is not greater than 2 μm; a metal structure after the continuous hot-dip galvanizing step includes a ferrite phase and not less than 15% by area and less than 45% by area of a second phase; and the second phase is composed of martensite or composed of martensite and bainite, and has an average crystal grain size of not greater than 8 μm.

The method of producing a hot-dip Zn—Al—Mg-based plated steel sheet in accordance with an aspect of the present invention may be arranged such that the steel substrate further contains at least one of the following: P in an amount of 0.005% by mass to 0.050% by mass; S in an amount of 0.001% by mass to 0.020% by mass; and Al in an amount of 0.005% by mass to 0.100% by mass.

The method of producing a hot-dip Zn—Al—Mg-based plated steel sheet in accordance with an aspect of the present invention may be arranged such that the steel substrate further contains at least one of the following: Nb in an amount of 0% by mass to 0.10% by mass; V in an amount of 0% by mass to 0.10% by mass; Cr in an amount of 0% by mass to 1.00% by mass; and Mo in an amount of 0% by mass to 1.00% by mass.

The method of producing a hot-dip Zn—Al—Mg-based plated steel sheet in accordance with an aspect of the present invention may be arranged such that: in a surface layer of the hot-dip Zn—Al—Mg-based plating, a black oxide of Zn is present; and a lightness L* of a surface of the surface layer of the hot-dip Zn—Al—Mg-based plating is not more than 60.

1. A hot-dip Zn—Al—Mg-based plated steel sheet having a hot-dip Zn—Al—Mg-based plating on a surface of a steel substrate, wherein:
the steel substrate contains C in an amount of 0.050% by mass to 0.180% by mass, Si in an amount of 0.001% by mass to 0.50% by mass, Mn in an amount of 1.00% by mass to 2.80% by mass, Ti in an amount of 0.01% by mass to 0.10% by mass, and B in an amount of 0.0005% by mass to 0.0100% by mass, with the balance including Fe and unavoidable impurities;
an average grain size of cementite after winding in a hot rolling step is not greater than 2 μm;
a metal structure after a continuous hot-dip galvanizing step includes a ferrite phase and not less than 15% by area and less than 45% by area of a second phase; and
the second phase is composed of martensite or composed of martensite and bainite, and has an average crystal grain size of not greater than 8 μm.

2. The hot-dip Zn—Al—Mg-based plated steel sheet as set forth in claim 1, further comprising at least one of the following: P in an amount of 0.005% by mass to 0.050% by mass; S in an amount of 0.001% by mass to 0.020% by mass; and Al in an amount of 0.005% by mass to 0.100% by mass.

3. The hot-dip Zn—Al—Mg-based plated steel sheet as set forth in claim 1, further comprising at least one of the following: Nb in an amount of 0% by mass to 0.10% by mass; V in an amount of 0% by mass to 0.10% by mass; Cr in an amount of 0% by mass to 1.00% by mass; and Mo in an amount of 0% by mass to 1.00% by mass.

4. The hot-dip Zn—Al—Mg-based plated steel sheet as set forth in claim 1, wherein:
in a surface layer of the hot-dip Zn—Al—Mg-based plating, a black oxide of Zn is present; and
a lightness L* of a surface of the surface layer of the hot-dip Zn—Al—Mg-based plating is not more than 60.

5. A method of producing a hot-dip Zn—Al—Mg-based plated steel sheet having a hot-dip Zn—Al—Mg-based plating on a surface of a steel substrate, comprising: a hot rolling step; a cold rolling step; and a continuous hot-dip galvanizing step in the order stated, the continuous hot-dip galvanizing step comprising sequentially carrying out annealing and hot-dip Zn—Al—Mg-based plating, wherein, in the hot rolling step,
an average cooling rate after hot rolling is not less than 20° C./second and less than 80° C./second, and
a winding temperature is not lower than 400° C. and lower than 600° C.

6. The method as set forth in claim 5, wherein:
the steel substrate contains C in an amount of 0.050% by mass to 0.180% by mass, Si in an amount of 0.001% by mass to 0.50% by mass, Mn in an amount of 1.00% by mass to 2.80% by mass, Ti in an amount of 0.01% by mass to 0.10% by mass, and B in an amount of 0.0005% by mass to 0.0100% by mass, with the balance including Fe and unavoidable impurities;
an average grain size of cementite after winding in the hot rolling step is not greater than 2 μm;
a metal structure after the continuous hot-dip galvanizing step includes a ferrite phase and not less than 15% by area and less than 45% by area of a second phase; and
the second phase is composed of martensite or composed of martensite and bainite, and has an average crystal grain size of not greater than 8 μm.

7. The method as set forth in claim 6, wherein the steel substrate further contains at least one of the following: P in an amount of 0.005% by mass to 0.050% by mass; S in an amount of 0.001% by mass to 0.020% by mass; and Al in an amount of 0.005% by mass to 0.100% by mass.

8. The method as set forth in claim 6, wherein the steel substrate further contains at least one of the following: Nb in an amount of 0% by mass to 0.10% by mass; V in an amount of 0% by mass to 0.10% by mass; Cr in an amount of 0% by mass to 1.00% by mass; and Mo in an amount of 0% by mass to 1.00% by mass.

9. The method as set forth in claim 5, wherein:
in a surface layer of the hot-dip Zn—Al—Mg-based plating, a black oxide of Zn is present; and
a lightness L* of a surface of the surface layer of the hot-dip Zn—Al—Mg-based plating is not more than 60.
